(19) United States
(12) Patent Application Publication
(10) Pub. No.: US 2004/0246360 A1
(43) Pub. Date: Dec. 9, 2004

(54) System and method for displaying preview images to a camera user

(76) Inventors: Donald J. Stavely, Windsor, CO (US); Christopher A. Whitman, Ft. Collins, CO (US); Robert E. Sobol, Ft. Collins, CO (US); Kevin J. Matherson, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/455,201

(22) Filed: Jun. 5, 2003

(51) Int. Cl. H04N 5/222

(52) U.S. Cl. 348/333.11

(57) ABSTRACT

Disclosed are systems and methods for displaying preview images to a camera user. In one embodiment, a system and method pertain to displaying liveview images in a camera display when an image is being composed, and further displaying at least one preview image in the camera display, the at least one preview image providing an indication of image focus or detail.

### BACKGROUND

Most digital cameras include a display, such as a back panel liquid crystal display (LCD) or an eyepiece microdisplay, that can be used to facilitate composition of an image before it is captured. In such a case, the camera operates in a liveview (or “movie”) mode in which many images are displayed to the user in rapid succession to emulate real time viewing of the subject scene. Although presentation of such liveview images provides convenience to the user, such images are often of relatively low quality as compared to images that are captured and stored in camera memory. This phenomenon can be observed by comparing the liveview images to a captured image.

There are several reasons why liveview images may be of relatively poor quality. For one, the liveview images may be relatively low resolution images in that many frames per second must be captured and displayed in the camera display to enable the perceived real time viewing of the object scene. For example, as many as thirty frames per second (fps) or more must be captured and displayed. In that image capture, data reading, and display requires processor time, such rapid display of liveview images may require significant downsampling of the image data and, therefore, lower resolution.

To cite another reason for relatively poor quality of liveview images, the photofinishing performed on liveview images is typically less effective than that performed on final captured images. For instance, the autoexposure and/or color balancing algorithms used to capture and finish the liveview images may be inferior to those used to autoexpose and color balance a final image. Such “corner cutting” reduces processing time and therefore also enables the rapid display of the liveview images.

Due to the relatively poor quality of the liveview images shown during image composition, it can be difficult for the user to know whether the camera is properly focused. For example, it may be difficult to tell whether a person that is the intended subject of the image is in focus or whether objects behind that person are instead in focus. Exacerbating the problem is the small size and relatively low resolution of typical camera displays. Typically, such displays are no larger than 1 inch by 1.5 inches, with resolutions of 320 by 240 pixels (quarter-VGA or QVGA). Some microdisplays are available with full VGA resolution (640 by 480 pixels).

Although the user can determine whether the intended subject was in focus after a final image is captured by reviewing the captured image immediately after its capture (and optionally “zooming in” on that captured image), it would be desirable to provide a better indication of the image focus and/or image details to the user before the image is captured so that the user need not review images after they are captured and recompose and recapture the image in the event that the captured image is considered unacceptable for some reason.

### SUMMARY

Disclosed are systems and methods for displaying preview images to a camera user. In one embodiment, a system and method pertain to displaying liveview images in a camera display when an image is being composed, and further displaying at least one preview image in the camera display, the at least one preview image providing an indication of image focus or detail.

### BRIEF DESCRIPTION OF THE DRAWINGS

The disclosed systems and methods can be better understood with reference to the following drawings. The components in the drawings are not necessarily to scale.

FIG. 1 is a rear view of an embodiment of an example camera that displays preview images.

FIG. 2 is an embodiment of an architecture of the camera shown in FIG. 1.

FIG. 3 is a flow diagram of a first embodiment of a method for displaying preview images to a user.

FIG. 4 is a flow diagram of a second embodiment of a method for displaying preview images to a user.

FIG. 5 is a flow diagram of a third embodiment of a method for displaying preview images to a user.

FIG. 6A is a schematic view of a liveview image that can be displayed in a camera display.

FIG. 6B is a schematic view of an embodiment of a zoomed preview image that can be displayed in a camera display.

FIG. 7 is a flow diagram of a fourth embodiment of a method for displaying preview images to a user.

### DETAILED DESCRIPTION

As identified in the foregoing, camera users often cannot identify detail from liveview images presented in a camera display and, therefore, typically cannot ascertain whether an image subject is or is not in focus. This problem is due in part to the relatively low quality of the liveview images that are displayed, as well as the relatively small size of the typical camera display. As is described in this disclosure, however, better feedback as to the focus and details of a composed image can be provided to the user by displaying preview images that convey more useful information to the user.

In one embodiment, a relatively high-quality still image is shown to the user during image composition. In another embodiment, zoomed liveview images are sequentially shown to the user during image composition. In yet a further embodiment, a relatively high-quality, zoomed still image is shown to the user during image composition. In each case, the preview images provide the user with a better indication as to the nature of the image that the user is about to capture.

Described below are systems and methods that provide image previews. Although particular embodiments are identified in an effort to fully describe the disclosed systems and methods, these embodiments are provided for purposes of example only.

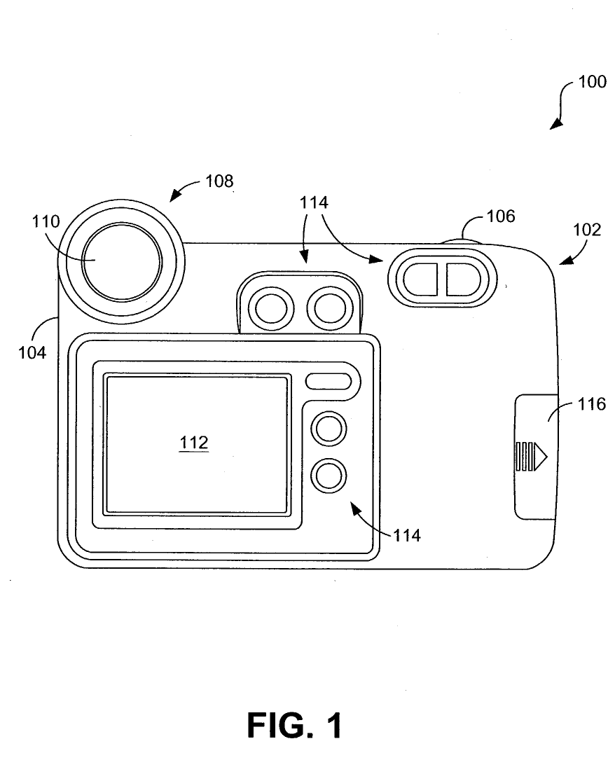

Referring now to the drawings, in which like numerals indicate corresponding parts throughout the several views, FIG. 1 illustrates an embodiment of a camera 100 that displays preview images to a camera user. In the example of FIG. 1, the camera 100 is a digital still camera. Although a digital still camera implementation is shown in the figures and described herein, the camera can, alternatively, comprise any camera that presents images to the user in a camera display during image composition.

As indicated in FIG. 1, the camera 100 includes a body 102 that is defined by an outer housing 104. The top portion of the camera 100 comprises a shutter button 106 that is used to open the camera shutter (not visible in FIG. 1). Formed with the camera body 102 is a viewfinder 108 that includes a view window 110. In cases in which the viewfinder 108 is an electronic viewfinder (EVF), the viewfinder contains a microdisplay (not visible in FIG. 1). In the example of FIG. 1, the back panel of the camera 100 includes a display 112 that, for example, comprises a liquid crystal display (LCD) or light emitting diode (LED) display.

Various control buttons 114 are also provided on the back panel of the camera 100. Alternatively, however, such buttons may be placed in other locations, such as the top of the camera 100. The buttons 114 can be used to, for instance, scroll through captured images shown in the display 112, make selections from camera menus, etc. Furthermore, at least one of these buttons 114 may be used during an image composition process to command presentation of one or more preview images that are indicative of the focus and/or details of the image that is about to be captured. Also shown in FIG. 1 is a compartment 116 that is used to house a battery and/or a memory card.

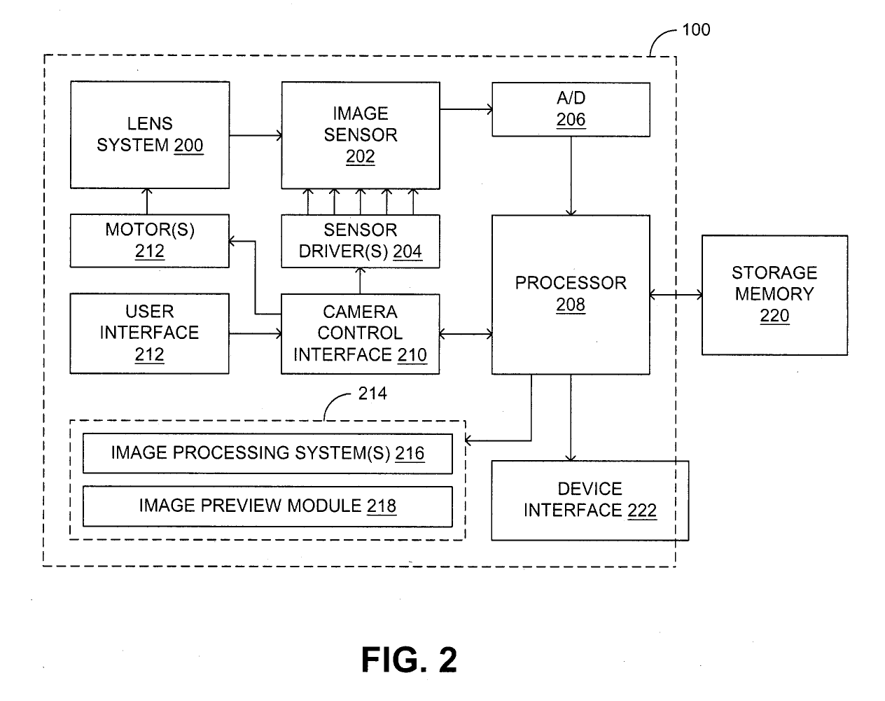

FIG. 2 illustrates an example architecture for the camera 100. As indicated in this figure, the camera 100 includes a lens system 200 that conveys images of viewed scenes to an image sensor 202. By way of example, the image sensor 202 comprises a charge-coupled device (CCD) or a complementary metal oxide semiconductor (CMOS) sensor that is driven by one or more sensor drivers 204. The analog image signals captured by the sensor 202 are provided to an analog-to-digital (A/D) converter 206 for conversion into binary code that can be processed by a processor 208.

Operation of the sensor driver(s) 204 is controlled through, a camera control interface 210 that is in bi-directional communication with the processor 208. Also controlled through the interface 210 are one or more motors 212 that are used to drive the lens system 200 (e.g., to adjust focus and optical zoom). Operation of the camera control interface 210 may be adjusted through manipulation of the user interface 212. The user interface 212 comprises the various components used to enter selections and commands into the camera 100 and therefore at least includes the shutter button 106 and the control buttons 114 identified in FIG. 1.

Digital image signals are processed in accordance with instructions from the camera control interface 210 and image processing system(s) 216 stored in permanent (non-volatile) device memory 214. The image processing systems 216 include photofinishing algorithms, such as color balancing algorithms. Processed images may be stored in storage memory 220, such as that contained within a removable solid-state memory card (e.g., Flash memory card). In addition to the image processing system(s) 216, the device memory 214 further comprises an image preview module 218 (i.e., logic) that, as is described in greater detail below, is used to display preview images to the user in a camera display (e.g., microdisplay or flat panel display). Although an image preview module 218 is shown in memory 214, the functionality provided by this module can, alternatively, be provided by logic incorporated into the processor 208 and/or the camera control interface 210, if desired.

The camera embodiment shown in FIG. 2 further includes a device interface 222, such as a universal serial bus (USB) connector, that is used to download images from the camera to another device such as a personal computer (PC) or a printer, and which likewise can be used to upload images or other information.

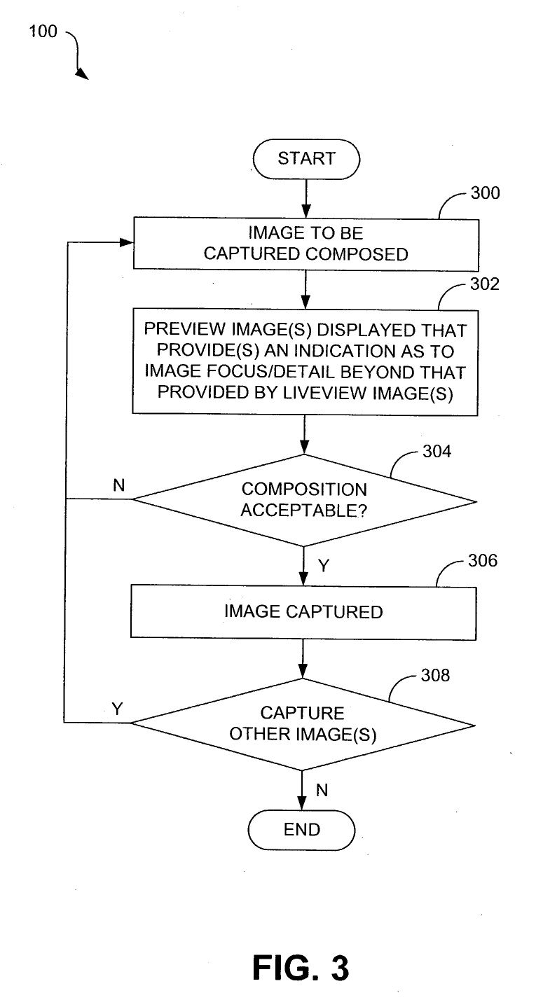

FIG. 3 is a flow diagram of a first embodiment of a method for displaying preview images to a user. More particularly, FIG. 3 provides an overview of operation of a camera such that one or more preview images are displayed for the user. It is noted that any process steps or blocks described in this or other flow diagrams of this disclosure may represent modules, segments, or portions of program code that includes one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 300 of FIG. 3, an image that is to be captured is composed. Composition may comprise one or more of aiming the camera at a subject scene, focusing on one or more scene objects, adjusting camera zoom such that only the desired objects are contained within the image frame, and so forth. It is noted that any focusing that occurs during image composition can be automatic (due to an autofocus function) or manual. While the image is being composed, liveview images may be displayed to the user in an appropriate camera display (e.g., EVF microdisplay or back panel display) to aid in the composition process. In such a case, the liveview images provide the user with a rough idea of the objects that will be contained in the image and the composition of the image in general.

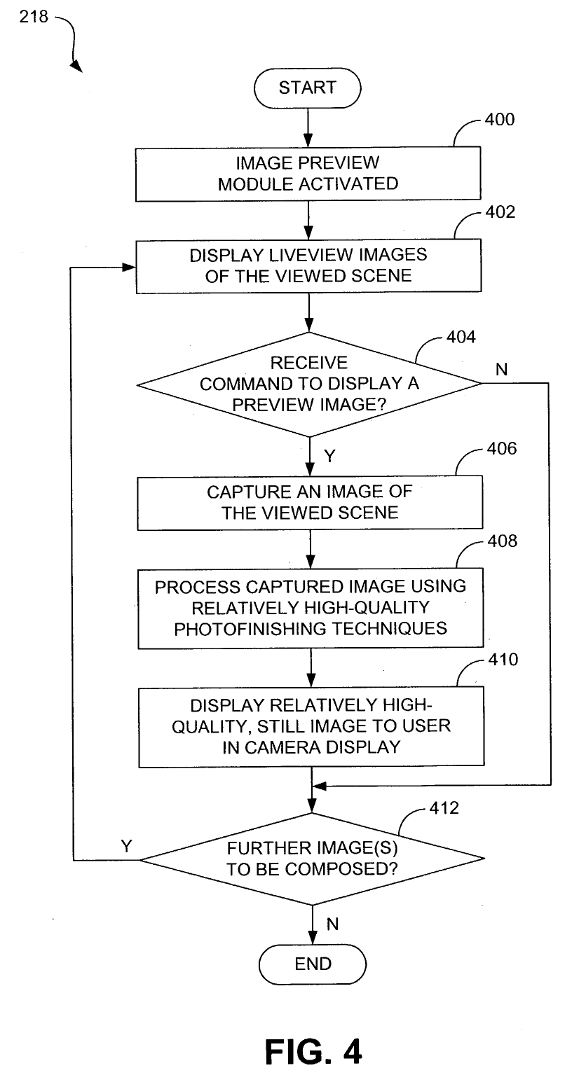

At some point during the image composition process, one or more preview images is/are displayed that provides or provide an indication as to the image focus and/or detail, as indicated in block 302. As is further indicated in block 302, the indication as to image focus/detail goes beyond that provided by the liveview images that may be presented to the user in the camera display. The nature of the preview image(s) depends upon the particular configuration of the camera or the mode in which it is operating. In one case, the preview image comprises a relatively high-quality still image similar to that displayed to a user after a final image is captured and stored in camera memory. In another case, the preview images are displayed that comprise zoomed liveview images that are shown sequentially to the user in rapid succession. In a further case, the preview image comprises a relatively high-quality, zoomed still image. Examples of the display of such preview images are described in relation to FIGS. 4-7 below. As is described in those examples, the preview image or images can be displayed, for example, in response to input of a user command.

After the displayed preview image or images is/are reviewed, it is determined whether the image composition is acceptable, as indicated in decision block 304. The criteria upon which this determination is made can include, for instance, the focus of target objects that the user wishes to capture, the objects that are visible, the lighting of the target objects, the general composition (e.g., artistic feel), etc. If the composition is not acceptable for some reason, flow returns to block 300 and the image is recomposed prior to capturing a final image. With this manner of operation, the user need not capture an unacceptable image, review it, learn of its unacceptable nature, erase it, and then recompose and recapture the image.

With reference back to block 304, if the composition is deemed acceptable, flow continues to block 306 at which a final image is captured and, optionally, stored in camera memory. At this point, it is determined whether another image is to be captured, as indicated in decision block 308. If so, flow returns to block 300 and an image is again composed. If not, however, flow for the image capture session is terminated.

FIG. 4 is a flow diagram of a second embodiment of a method for displaying preview images to a user. More particularly, FIG. 4 provides an example of operation of the image preview module 218 of the camera 100. Beginning with block 400 of FIG. 4, the image preview module 218 is activated. This activation occurs when the camera is placed in an image capture mode such that the module 218 is active during image composition. As in the method described in relation to FIG. 3, image composition may comprise one or more of aiming the camera at a subject scene, focusing on one or more scene objects, adjusting camera zoom such that only the desired objects are contained within the image frame, and so forth.

As is indicated in block 402, it is presumed in this example that liveview images of the viewed scene are displayed to the user in a camera display to aid the user in composing the image. Although the liveview images need not comprise low-quality images, it is assumed the liveview images are of relatively low quality due to the speed with which images are presented to the user and/or processing limitations of the camera. In some embodiments, the relatively low quality may be the result of aggressive downsampling and/or rapid photofinishing that may be necessary to emulate real time viewing of the observed scene.

With reference next to decision block 404, the image preview module 218 determines whether a command to display a preview image is received. Such a command can be input by the user in a variety of ways. In some cases, the user may press a dedicated preview button provided on the camera. In other cases, the user may press the camera shutter button to a halfway position (i.e., the S1 position) to communicate the command. In any case, if such a command is not received, no preview images are displayed to the user and the image must be composed using either the displayed liveview images or a camera viewfinder. Flow then continues down to decision block 412 described below.

If a command to display a preview image is received at block 404, flow continues to block 406 at which the image preview module 218 causes an image to be captured of the viewed scene. The nature of the captured image may depend upon the configuration and capabilities of the camera. For instance, if relatively low resolution (e.g., quarter-VGA or QVGA) liveview images are presented in the camera display during image composition, the image captured in block 406 can comprise a relatively high resolution (e.g., VGA) image (assuming that the camera display has VGA resolution). Such an image can be obtained, for instance, by merely downsampling the image data collected by the camera image sensor to a lesser degree. In that, as is described below, the captured image is going to be presented as a still image (i.e., for a relatively long period of time), the aggressive downsampling that may be used to display liveview images is not necessary in generating the preview image of this method.

Once an image is captured in the manner described above, the image is processed using relatively high-quality photofinishing techniques, as indicated in block 408. In the present context, “high-quality photofinishing techniques” identifies those techniques that result in relatively high image quality, and may be contrasted to the relatively low-quality photofinishing techniques that are typically used to quickly process liveview images prior to their display. For example, the color balancing algorithm that is used to process a final captured image may be used in clock 408. Use of such can an algorithms as opposed to the algorithms used in the rapid photofinishing performed on liveview images, is possible due to the fact that the image is to be presented as a still image.

Referring next to block 410, the module 218 displays a relatively high-quality, still image (i.e., a preview image) to the user in the camera display. By “high-quality” is meant a sharper and/or cleaner image than the liveview images. Such improved quality may be the result of increased resolution, the application of better photofinishing algorithms, or both. By way of example, the preview image is displayed as long as the command to display it continues to be received. For instance, the preview image may be displayed as long as a dedicated preview button or the shutter button (in the S1 position) is pressed and held. Because of its higher quality, the preview image provides a good indication of a final image that may be captured. Therefore, a preview is provided to the user that is closer to what-you-see-is-what-you-get (WYSIWYG) than the liveview images.

As noted above in relation to FIG. 3, if the preview image appears acceptable, the user can then capture the image. If the image is unacceptable, however, the user has the opportunity to recompose the image before it is captured. With reference then to decision block 412, it is next determined whether another image is to be composed. If so, flow returns to block 402 and the above-described process is performed again. If not, flow for the session is terminated until the next time the image preview module 218 is activated.

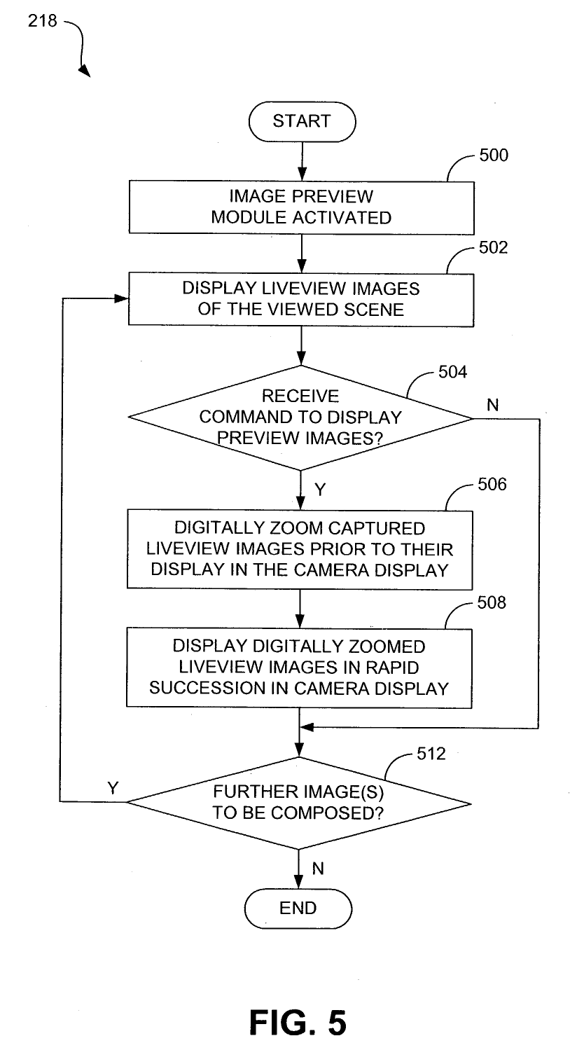

FIG. 5 is a flow diagram of a third embodiment of a method for displaying preview images to a user and, more particularly, provides a further example of operation of the image preview module 218. Beginning with block 500 of FIG. 5, the image preview module 218 is activated. Again, this activation occurs when the camera is placed in an image capture mode such that the module 218 is active during image composition. Once activation has occurred, liveview images of the viewed scene are displayed to the user in the camera display. With reference next to decision block 504, the image preview module 218 determines whether a command to display preview images is received. As in the embodiment described above in relation to FIG. 4, such a command can be input by the user, for example, by pressing a dedicated preview button or the camera shutter button.

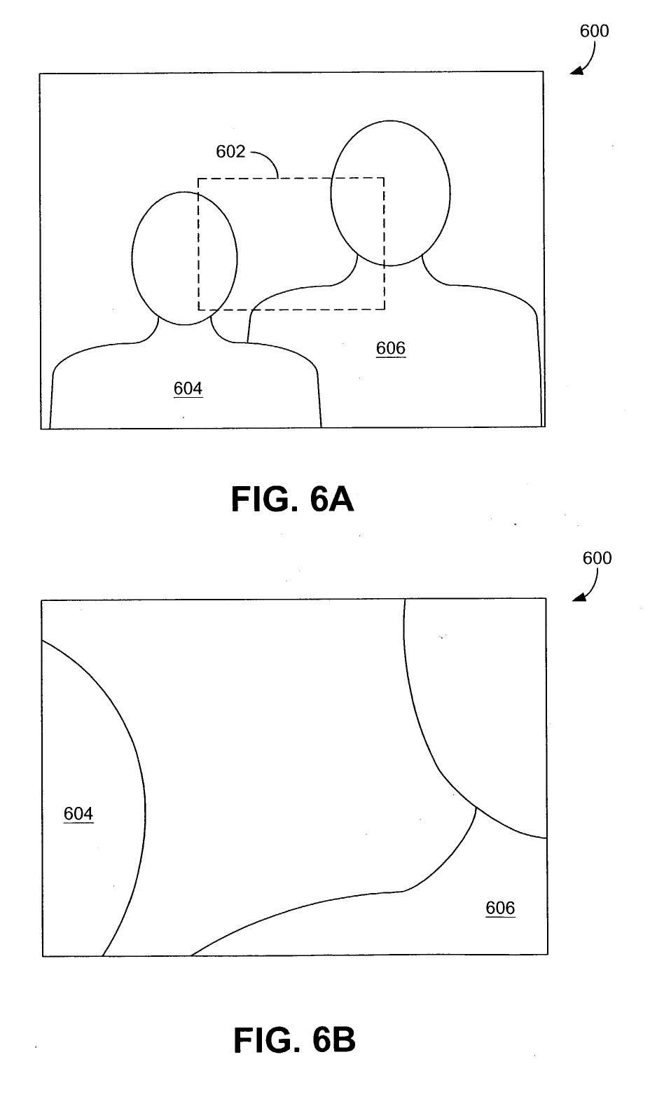

If a command to display preview images is received, irrespective of the manner in which the command was input, flow continues to block 506 at which the image preview module 218 digitally zooms the captured liveview images prior to their being displayed in the camera display. Such zooming is accomplished through image processing alone. In particular, captured liveview images are cropped, and the cropped images are then enlarged so to be of a size that will fill the camera display. This process is illustrated by FIGS. 6A and 6B. FIG. 6A illustrates a composed image 600 and, more particularly, a single liveview image that may be presented in the camera display. An area 602 may be defined that will be used to generate the zoomed image. In other words all image data beyond the boundaries of the area 602 is discarded to therefore crop the image 600. Next, the area 602 is enlarged, as depicted in FIG. 6B, so that objects 604, 606 of the image are likewise enlarged. It is noted that, because no optical zooming is performed to achieve this zooming, the lenses of the camera lens system are not displaced and, therefore, a final image may be captured at will without the need to wait for the lens system to be repositioned into an initial position in which the image was first composed.

Referring next to block 508, the image preview module 218 displays digitally zoomed liveview images (such as the example image of FIG. 6B) in rapid succession in the camera display so that a substantially real time, zoomed-in view of the composed image is shown to the user. As noted above, standard liveview images typically comprise relatively low-quality images that may be a result of the relative low resolution (e.g., ¼ VGA) of the display. Moreover, the size of the display may be very small (e.g., 1-3 square inches in area). These factors make the focus of the image difficult to ascertain. However, if the liveview images are shown in a digitally-zoomed format, as indicated in FIG. 6B, the sharpness of the edges of the target objects can be determined more easily because the scene objects are enlarged. Moreover, a greater number of captured image data can be used to create the zoomed image, in effect improving image resolution. For example, if an approximately 2× zoom is performed on a liveview image (i.e., such that about half of the rows and half of the columns of the image or about 25% of the original image area is used to form a resultant zoomed image), a camera display having QVGA resolution can display each pixel of an image captured by the image sensor sampled with VGA resolution. While this is still not the full resolution of the final image, it may be sufficient to determine if the subject is in reasonable focus. Of course, higher digital zoom factors than 2× also possible

As noted above with reference to the method of FIG. 4, the preview images (zoomed liveview images in this case) may be displayed to the user as long as the user command to do so is communicated, for instance, by depression of a dedicated preview button or the shutter button. If, after inspecting the zoomed liveview images, the user determines that the image that will be captured is acceptable (e.g., in proper focus), the user can at that time release the button to end the preview, and capture and store the image by fully depressing the shutter button.

With reference next to decision block 512, it is determined whether another image is to be composed. If so, flow returns to block 502 and the above-described process is performed again. If not, flow for the session is terminated until the next time the image preview module 218 is activated.

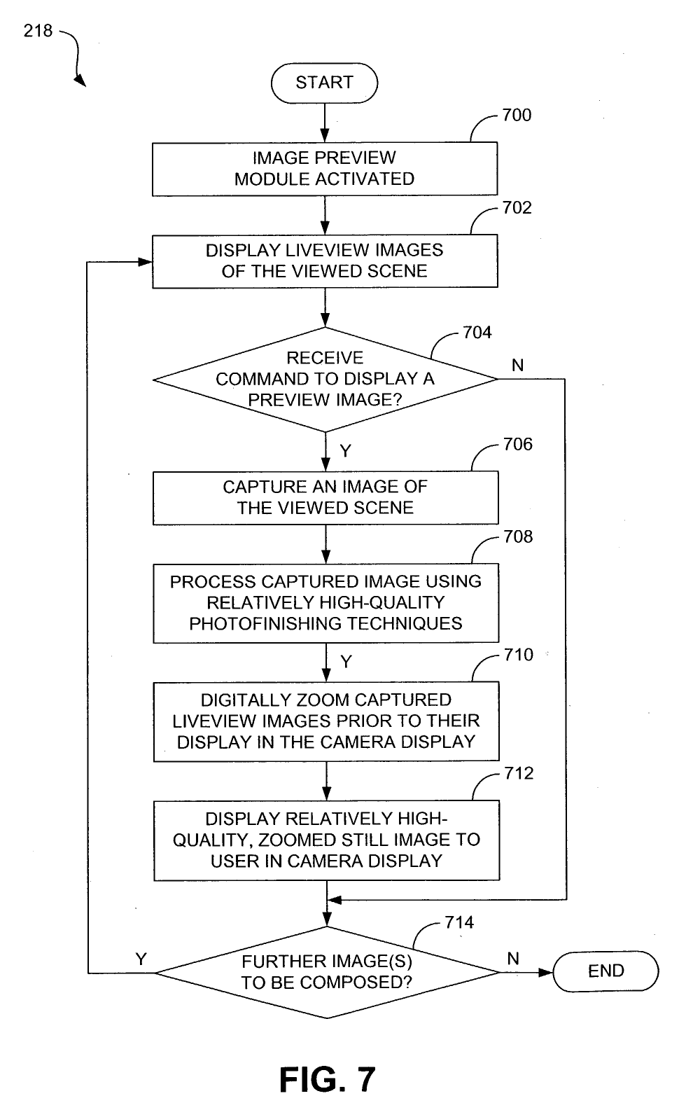

FIG. 7 is a flow diagram of a fourth embodiment of a method for displaying preview images to a user. More particularly, FIG. 7 provides an example of operation of the image preview module 218 in which a relatively high-quality, zoomed still image is displayed to the user. Accordingly, the method of FIG. 7 represents a hybrid method combining aspects of the methods described in relation to FIGS. 4 and 5.

Beginning with block 700 of FIG. 7, the image preview module 218 is activated and, as indicated in block 702, liveview images of the viewed scene are displayed to the user in a camera display to aid the user in composing an image. Next, the image preview module 218 determines whether a command to display a preview image is received, as indicated in decision block 704. If such a command is not received, no preview image is displayed to the user and the image must be composed using either the displayed liveview images or a camera viewfinder alone. Flow then continues down to decision block 712 described below.

If a command to display a preview image is received at block 704, flow continues to block 706 at which the image preview module 218 causes an image to be captured of the viewed scene. As described in relation to FIG. 4, the image can comprise a relatively high resolution (e.g., VGA) image. Once an image is captured, the image is processed using relatively high-quality photofinishing techniques, as indicated in block 708. In some embodiments, the image is processed using algorithms that are used to process a final captured image, such as color balance, tone reproduction, etc. Use of such algorithms, as opposed to the algorithms used to perform rapid photofinishing on liveview images, is possible due to the fact that the image is to be presented as a still image.

With reference to block 710, the image preview module 218 digitally zooms the captured image by, for instance, cropping and enlarging the image so that it can fill the camera display. Once such zooming has been performed, the module 218 displays a relatively high-quality, still image to the user in the camera display, as indicated in block 712. Again, this preview image is displayed as long as the command to display it continues to be received. For instance, the preview image may be displayed as long as a dedicated preview button or the shutter button (in the S1 position) is depressed. As in the method of FIG. 4, in cases in which the same photofinishing algorithms used to process a final image are used to generate the preview image, the preview image provides a good indication of a final image that may be captured. Therefore, a preview is provided to the user that is closer to what-you-see-is-what-you-get (WYSIWYG) than the liveview images. In the embodiment of FIG. 7, however, the image is further zoomed so that details, such as image focus can be readily determined.

With reference to decision block 714, it is then determined whether another image is to be composed. If so, flow returns to block 702 and the above-described process is performed again. If not, flow for the session is terminated until the next time the image preview module 218 is activated.

What is claimed is:

1. A method for displaying preview images, comprising:
displaying liveview images in a camera display when an image is being composed; and
during image composition displaying at least one preview image in the camera display, the at least one preview image providing an indication of image focus or detail.

2. The method of claim 1, wherein displaying liveview images comprises displaying a plurality of liveview images in the camera display in rapid succession to emulate real time viewing of an observed scene.

3. The method of claim 1, wherein displaying at least one preview image comprises displaying a still image that is of relatively high quality in relation to the displayed liveview images.

4. The method of claim 1, wherein displaying at least one preview image comprises displaying zoomed images in rapid succession.

5. The method of claim 1, wherein displaying at least one preview image comprises displaying a zoomed still image that is of relatively high quality relative to the displayed liveview images.

6. The method of claim 1, further comprising receiving a command to display a preview image prior to displaying at least one preview image.

7. The method of claim 6, wherein receiving a command comprises receiving a command input by the user with a dedicated preview button.

8. The method of claim 6, wherein receiving a command comprises receiving a command input by the user with a shutter button.

9. A method for displaying preview images, comprising:
displaying liveview images in a camera display when an image is being composed;
receiving a user command to display a preview image;
capturing an image of a viewed scene;
processing the captured image; and
displaying a still image in the camera display, the still image being of relatively high quality in relation to the displayed liveview images and being displayed as long as commanded by the user.

10. The method of claim 9, wherein receiving a user command comprises receiving a command via a camera button that is pressed by the user.

11. The method of claim 9, wherein capturing an image comprises capturing a relatively high resolution image.

12. The method of claim 9, wherein processing the captured image comprises photofinishing the captured image using at least one photofinishing algorithm that is used to process a final captured image.

13. The method of claim 9, further comprising digitally zooming the captured image, and wherein displaying a still image comprises displaying a zoomed still image in the camera display.

14. A method for displaying preview images, comprising:
displaying liveview images in a camera display when an image is being composed;
receiving a user command to display at least one preview image;
digitally zooming at least one captured image; and
displaying at least one zoomed image in the camera display.

15. The method of claim 14, wherein receiving a user command comprises receiving a command via a camera button that is pressed by the user.

16. The method of claim 14, wherein displaying at least one zoomed image comprises displaying a plurality of zoomed images in the camera display in rapid succession.

17. The method of claim 14, wherein displaying at least one zoomed image comprises displaying a zoomed still image that is of higher quality than that of the displayed liveview images.

18. A system for displaying preview images, comprising:
logic configured to display liveview images in a camera display; and
logic configured to display at least one preview image distinct from the displayed liveview images, the at least one preview image providing an indication of image focus or detail.

19. The system of claim 18, wherein the logic configured to display at least one preview image comprises logic configured to display a still image that is of relatively high quality in relation to the displayed liveview images.

20. The system of claim 18, wherein the logic configured to display at least one preview image comprises logic configured to display zoomed images in rapid succession.

21. The system of claim 18, wherein the logic configured to display at least one preview image comprises logic configured to display a zoomed still image that is of relatively high quality relative to the displayed liveview images.

22. A system for displaying preview images, comprising:
means for capturing images of a viewed scene;
means for displaying liveview images of the viewed scene; and
means for displaying at least one preview image distinct from the displayed liveview images, the at least one preview image providing an indication of image focus or detail.

23. The system of claim 22, wherein the means for displaying at least one preview image comprise means for displaying a still image that is of relatively high quality in relation to the displayed liveview images.

24. The system of claim 22, wherein the means for displaying at least one preview image comprise means for displaying zoomed images in rapid succession.

25. The system of claim 22, wherein the means for displaying at least one preview image comprise means for displaying a zoomed still image that is of relatively high quality relative to the displayed liveview images.

26. A digital camera, comprising:
an image sensor;
a processor that processes image data collected by the image sensor;
a camera display that is configured to display images processed by the processor; and
memory comprising an image preview module that is configured to display liveview images in the camera display when an image is being composed and display at least one preview image in the camera display, the at least one preview image providing an indication of image focus or detail.

27. The camera of claim 26, wherein the image preview module is configured to display a still image that is of relatively high quality in relation to the displayed liveview images.

28. The camera of claim 26, wherein the image preview module is configured to display zoomed images in rapid succession.

29. The camera of claim 26, wherein the image preview module is configured to display a zoomed still image that is of relatively high quality relative to the displayed liveview images.
